(19) United States
(12) Patent Application Publication
(10) Pub. No.: US 2006/0080555 A1
(43) Pub. Date: Apr. 13, 2006

(54) Data synchronization systems and methods for PDAS

(75) Inventor: Chung Chih Tung, Taipei (TW)

Correspondence Address: QUINTERO LAW OFFICE, 1617 BROADWAY, 3RD FLOOR, SANTA MONICA, CA, 90404, US

(73) Assignee: MITAC TECHNOLOGY CORP., HSIN-CHU HSIEN (TW)

(21) Appl. No.: 10/963,040

(22) Filed: Oct. 12, 2004

(51) Int. Cl. H04L 9/32; G06F 12/14

(52) U.S. Cl. 713/189; 713/175; 709/203

(57) ABSTRACT

A data synchronization system and method for PDAs. The system includes a network space and a PDA. The network space is connected to the Internet, and stores service data. The PDA has a mobile communication unit. The PDA directs the mobile communication unit to connect to the network space via a wireless telecommunication network, and performs a specific process on the service data.

### BACKGROUND

The present disclosure relates generally to data synchronization for PDAs, and, more particularly, to a data synchronization system and method for PDAs that directly synchronizes data or installs applications from a network space via a mobile communication unit.

Recently, with the price and functionality improvement of PDAs, portable PDAs have become widely used. PDAs, however, having limited memory and some complicated operations require synchronization of data with a personal computer via an universal serial bus, infrared, or communication port.

Since data synchronization must be performed with a personal computer, flexibility is limited.

Referring to FIG. 1, FIG. 1 is a schematic diagram illustrating a conventional synchronization process between a PDA and a personal computer. When a PDA 10 requires synchronization, it first connects to a personal computer 30 by infrared, or with a cable via a communication port or a universal serial bus (20). A synchronization program on the PDA 10 (not shown in FIG. 1) can then be used to synchronize data or download and install applications from the personal computer 30.

Currently, mobile communication technologies provide high speed data transmission. For example, the transmission bandwidth based on general packet radio service (GPRS), personal handy-phone system (PHS), or code-division multiple access (CDMA) has reached, even surpassed that based on integrated services digital network (ISDN). Additionally, mobile communication technologies can be easily integrated into PDAs, such that PDAs can conveniently connect to the Internet.

### SUMMARY

Embodiments of the invention provide a data synchronization system and method for PDAs. PDAs can synchronize data or install applications from a network space over the Internet via a mobile communication unit. According to some embodiments of the invention, the data synchronization system includes a network space and a PDA. The network space is connected to the Internet, and stores service data. The PDA comprises a mobile communication unit. The PDA connects to the network space via a wireless telecommunication network using the mobile communication unit, and performs a specific process on the service data.

The PDA further transmits a PDA serial number and a password to the network space. The network space checks the PDA serial number and the password to recognize the PDA. The mobile communication unit and the network space are connected via a wireless telecommunication system.

Embodiments of the invention further provide a data synchronization method. A connection signal is first transmitted by a mobile communication unit of a PDA. The connection signal is then received by a network space, and service data is provided to the PDA, and a specific process is performed on the service data in response to the connection signal.

Similarly, a PDA serial number and a password are further transmitted to the network space from the PDA. The PDA is recognized by the network space by checking the PDA serial number and the password. The mobile communication unit and the network space are connected via a wireless telecommunication system.

The service data may be timesensitive data, such as email, exchange rates, news, schedules, and the like. Further, the service data may be an application, and the specific process may be downloading and installing an application on the PDA.

### BRIEF DESCRIPTION OF THE DRAWINGS

Embodiments of the invention will become apparent by referring to the following detailed description with reference to the accompanying drawings, wherein:

FIG. 1 is a schematic diagram illustrating a conventional synchronization process between a PDA and a personal computer;

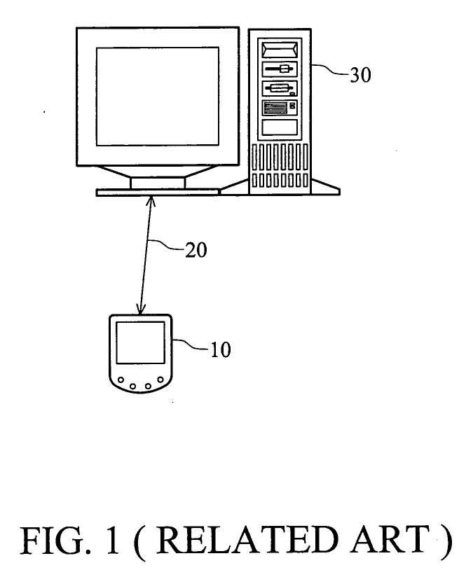

FIG. 2 is a schematic diagram illustrating the data synchronization system for PDAs according to an embodiment of the invention; and

FIG. 3 is a flowchart showing the data synchronization method for PDAs according to an embodiment of the invention.

### DESCRIPTION

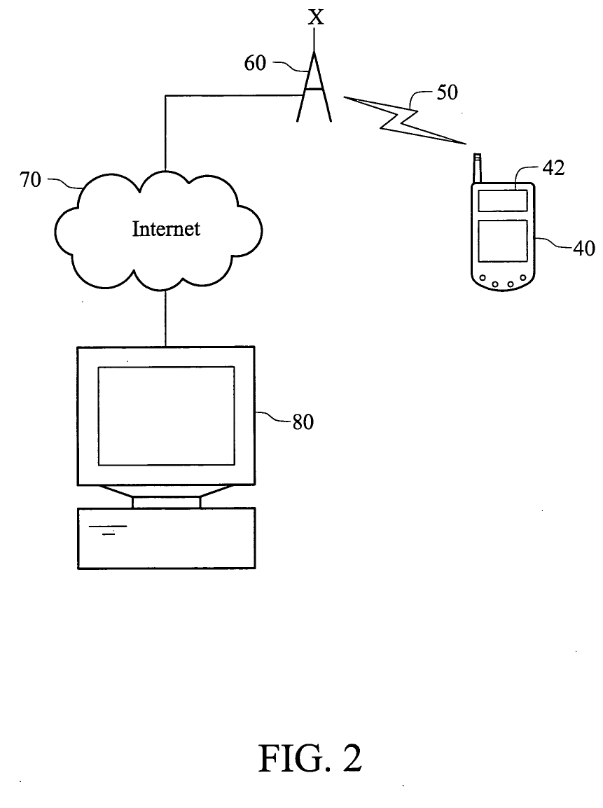

Referring to FIG. 2, FIG. 2 is a schematic diagram illustrating the data synchronization system for PDAs according to an embodiment of the invention.

The data synchronization system includes a PDA 40, a wireless telecommunication system (base station) 60, and a network space 80. The PDA 40 comprises at least a mobile communication unit 42, and has a PDA serial number provided during production (not shown in FIG. 2).

The network space 80 may be a network server providing various services. The network space 80 provides timesensitive data, such as email, exchange rates, news, schedules, and the like. The network space 80 further provides applications for downloading by the PDA 40 connected to the network space 80. It is understood that the data provided by the network space 80 can be maintained by the user of the PDA 40 and the system provider of the network space 80.

When the PDA 40 requires to connect to the network space 80 for data synchronization, the PDA 40 directs the mobile communication unit 42 to transmit a connection signal via a wireless telecommunication network 50 to request connection with the wireless telecommunication system 60. The wireless telecommunication system 60 then connects to the network space 80 via Internet 70, thereby establishing a channel for data synchronization between the PDA 40 and the network space 80.

In some embodiments of the invention, the wireless telecommunication system (60) and network (50) may conform to global system for mobile communication (GSM), general packet radio services (GPRS), personal handy-phone system (PHS), code-division multiple access (CDMA), and others, but not limited thereto.

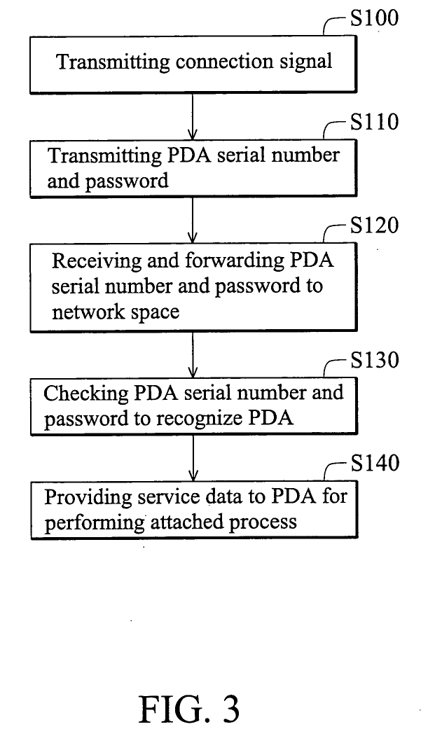

FIG. 3 is a flowchart showing the data synchronization method for PDAs according to an embodiment of the invention. Referring to FIGS. 2 and 3, a detail description of the invention follows.

First, when the PDA 40 requires data synchronization or application downloading and installation, in step S100, the PDA 40 directs the mobile communication unit 42 to transmit a connection signal via the wireless telecommunication network 50. The connection signal comprises related information regarding to the location or address of the designated network space 80.

In step S110, the PDA 40 further directs the mobile communication unit 42 to transmit a unique PDA serial number and a password for recognition and verification via the wireless telecommunication network 50. The password can be preset on the network space 80 using the PDA 40 or a personal computer connected to the network space 80.

It is understood that the PDA serial number and the password transmitted in step S110 can be integrated into the connection signal in step S100. Further, the user of the PDA 40 can use a simple selection or operation to establish the connection to the network space 80.

Then, in step S120, the wireless telecommunication system 60 receives the connection signal, the PDA serial number, and the password from the PDA 40, and forwards the PDA serial number and the password to the network space 80 via Internet 70 according to the connection signal.

After the network space 80 receives the PDA serial number and the password forwarded by the wireless telecommunication system 60, in step S130, the network space 80 checks the PDA serial number and the password to recognize the PDA 40, and verify the access authority of the PDA 40.

After the PDA 40 is recognized, in step S140, the network space 80 provides various timesensitive data, such as email, exchange rates, news, schedules, and the like to the PDA 40, and the PDA 40 can select specific data for synchronization via Internet 70 and the wireless telecommunication network 50. Further, the network space 80 provides applications, and the PDA 40 can select specific applications for downloading and installation via Internet 70 and the wireless telecommunication network 50.

Embodiments of the invention thus provide a data synchronization system and method for PDAs that directly synchronizes timesensitive data or installs applications from a network space connected to the Internet via a mobile communication unit without specific place (home or office) and device (personal computer) limitations.

Further, the embodiments of the invention provide the following potential advantages. Since the network space can recognize a respective PDA according to a corresponding unique serial number and password, the system provider can allocate resources to other business or related data and applications. Further, since applications are installed over the Internet, and no source code is available for PDAs, intellectual property is thereby protected.

Embodiments of the method and system, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the embodiment. Embodiments of the method and system may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the embodiments. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those skilled in this technology can still make various alterations and modifications without departing from the scope and spirit disclosed.

What is claimed is:

1. A system for synchronizing data between PDAs and a network space, comprising:
a network space connected to the Internet, storing service data; and
a PDA comprising a mobile communication unit to connect to the network space via a wireless telecommunication network using the mobile communication unit, and perform a specific process on the service data.

2. The system of claim 1 wherein the PDA further transmits a PDA serial number and a password to the network space, and the network space checks the PDA serial number and the password to recognize the PDA.

3. The system of claim 1 wherein the mobile communication unit and the network space are connected via a wireless telecommunication system.

4. The system of claim 1 wherein the network space comprises a network server.

5. The system of claim 1 wherein the service data comprises timesensitive data.

6. The system of claim 5 wherein the timesensitive data comprises email, exchange rates, news, or schedules.

7. The system of claim 5 wherein the specific process comprises synchronization of the timesensitive data.

8. The system of claim 1 wherein the service data comprises at least one application.

9. The system of claim 8 wherein the specific process comprises downloading and installation of the application.

10. A data synchronization method for PDAs from a network space, comprising:
transmitting a connection signal to a wireless telecommunication network by a PDA;
reception of the connection signal by a network space, and providing service data to the PDA, for performing a specific process on the service data in response to the connection signal.

11. The method of claim 10 further comprising transmitting the connection signal comprising a PDA serial number and a password to the network space.

12. The method of claim 11 further comprising check of the PDA serial number and the password to recognize the PDA by the network space.

13. The method of claim 10 further comprising connection between the mobile communication unit and the network space by a wireless telecommunication system.

14. The method of claim 10 wherein the network space comprises a network server.

15. The method of claim 10 wherein the service data comprises timesensitive data.

16. The method of claim 15 wherein the timesensitive data comprises email, exchange rates, news, or schedules.

17. The method of claim 15 further comprising performing the specific process by synchronizing the timesensitive data.

18. The method of claim 15 wherein the service data comprises at least one application.

19. The method of claim 18 further comprising performing the specific process by downloading and installing the application.
